(19) United States
(12) Patent Application Publication
(10) Pub. No.: US 2006/0191911 A1
(43) Pub. Date: Aug. 31, 2006

(54) Blanket with metal coated filaments for heating

(75) Inventors: Frank T. McNally, Kennett Square, PA (US); William F. McNally, Clarks Summit, PA (US); Tony Sosnowski, Stroudsburg, PA (US); N. Satish Chandra, Landsdale, PA (US)

Correspondence Address: AKERMAN SENTERFITT, P.O. BOX 3188, WEST PALM BEACH, FL, 33402-3188, US

(73) Assignee: Noble Fiber Technologies, Inc., Clarks Summit, PA (US)

(21) Appl. No.: 11/331,879

(22) Filed: Jan. 12, 2006

Related U.S. Application Data
(60) Provisional application No. 60/643,846, filed on Jan. 14, 2005.

(51) Int. Cl. H05B 6/10

(52) U.S. Cl. 219/645

(57) ABSTRACT

A blanket system having a blanket with at least one strip of conductive fibers coupled to a power source for providing heat to vital aspects of a person. The blanket system may include a blanket with one or more conductive strips formed from metal coated filaments, such as silver coated filaments, for effectively converting electricity to heat and delivering that heat to a person suffering from hypothermia or other needs. The blanket may be coupled to a portable power source enabling the blanket system to be used by hikers, hunters, other outdoorsman, sports fans and by others in other applications. The metal coated filaments are capable of conducting electricity yet retain the flexibility of an uncoated filaments. Such filaments enable a blanket to be very flexible, launderable, and comfortable to a user.

### CROSS-REFERENCE TO RELATED APPLICATIONS

This application claims the benefit of U.S. Provisional Application No. 60/643,846, filed Jan. 14, 2005.

### FIELD OF THE INVENTION

This invention is directed generally to blankets, and more particularly to electric blankets useful in emergency situations and other uses.

### BACKGROUND

Conventional electric blankets often are formed from blankets having copper wires woven, sewn, or otherwise coupled to the blankets. Such blankets are typically not very durable because the copper wires are susceptible to breakage that can render the wires inoperable. In addition, conventional electric blankets are typically not capable of being laundered using conventional equipment because of the risk of breakage of the copper wires and associated connectors. The copper wires also create the potential for overheating due to the solid configuration of the wire. Such overheating often results in burns to a person. Conventional electric blankets are also typically powered by municipal power sources and are attachable to a standard electric outlet. Such reliance on a municipal power source prevents use of the conventional electric blankets in many applications.

Conventional blankets, whether electric or non-electric, also are typically very bulky. Such blankets are often wrapped around a victim of hypothermia to increase the temperature of the person. For instance, a blanket is typically wrapped around a person to increase the temperature of vital aspects of the person, such as the head, chest and back of the body. Wrapping a person with a conventional blanket does not always enable medical care personnel to further assist the person. In addition, some people are claustrophobic and do not fair well being wrapped tightly with a blanket. Thus, there exists a need for a blanket for heating a person while overcoming the deficiencies of the conventional devices.

### SUMMARY OF THE INVENTION

This invention is directed to a blanket system configured to apply heat to vital areas of a living being. The blanket system may be formed from a blanket including one or more strips of conductive materials coupled to a power source for applying heat to vital aspects of a living being, such as a person or animal. The blanket may be configured such that heat may be applied to vital areas of a living being without having to wrap unduly cumbersome blankets completely around a living being. Rather, the blanket may be configured to cover only vital areas, or to only apply heat to vital areas of a living being, thereby eliminating undesirable blanket bulk around the person. The blanket system may be made of fabrics that are more flexible and less bulky than conventional blankets.

The blanket may be formed from a fabric formed from a nonconductive material and at least one strip containing metal coated filaments. The at least one strip containing metal coated filaments may include a first strip and a second strip that are separated by a third strip, wherein the first and second strips are formed from metal coated filaments for concentrating heat in close proximity to vital aspects of a living being, and the third strip may be nonconductive. The power source may be coupled to the first strip and the second strip. The metal coated filaments may be coated with silver or other appropriate materials. The silver coated filaments are very flexible and resilient, which enables the filaments to be plied numerous times without compromising the integrity of the filaments. The first and second conductive strips of material may be formed solely of metal coated filaments or may be partially formed from metal coated filaments. In one embodiment, the first and second conductive strips may be formed from between about 20 percent and about 40 percent metal coated filaments by weight of the strips. The metal coated filaments may be a staple yarn in a non-woven construction or may be formed from other appropriate configurations. The metal coated filaments may also be attached to a fabric via needle punch or other appropriate manner. The fabric may be woven, non-woven, ripstop, plain weave or formed in other appropriate configurations. In one embodiment, the first, second, and third strips may be about five inches in width.

The power source may be any appropriate power source capable of supplying electricity to the metal coated filaments. In at least one embodiment, the power source may be a portable power source, such as, but not limited to a battery, such as a conventional 12 volt battery, a portable battery, or other appropriate conventional battery. The power source may also be a photovoltaic cell, a municipal power source, or other appropriate power source. In at least one embodiment, the power source may be configured such that the temperature of the blanket, and specifically, the conductive strip, may be taken from about 30 degrees Fahrenheit to about 105 degrees Fahrenheit for about 2.5 hours.

The blanket system may be used to heat a living being, such as a person or animal by placing the blanket on the living being. The conductive strips of the blanket should be placed in close proximity to the vital aspects of a living being, such as the head, chest, and back of a person. The power source may be actuated such that electricity is sent to the conductive strips containing metal coated filaments.

An advantage of this invention is that the blanket may emit heat at a temperature of about 105 degrees Fahrenheit for an extended period of time while being flexible and launderable. The conductive strips of the blanket that emit heat are flexible and may be positioned in the blanket such that the conductive strips can be placed proximate to vital aspects of a living being. Thus, the blanket, in some embodiments, may be sized to fit close to the torso of a person or animal.

Another advantage of this invention is that the blanket system may be made portable and lightweight such that the blanket may be easily packed in a day pack as a safety item for outdoorsman and others.

Yet another advantage of this invention is that the blanket is launderable, unlike conventional electric blankets.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of the blanket system of this invention.

FIG. 2 is a table depicting resistance values for 100 xs 34 two-ply silver coated filaments that are patterned stitched.

FIG. 3 is a table depicting resistance values for 100 xs 34 one-ply silver coated filaments that are patterned stitched.

### DETAILED DESCRIPTION OF THE INVENTION

This invention is directed to a blanket system 10 configured to apply heat to vital areas of a living being. For instance, the blanket system 10 may be configured such that heat may be applied to vital areas of a living being without having to wrap unduly cumbersome blankets completely around a living being, such as a person or animal. Rather, the blanket system 10 may be configured to cover only vital areas, or only apply heat to vital areas of a living being, thereby eliminating undesirable blanket bulk around the person. The blanket system 10 may be made of fabrics that are more flexible and less bulky than conventional blankets.

In at least one embodiment, the blanket system 10 may be formed from a blanket 12 formed from a fabric 14 that may include a nonconductive material and one or more strips 16 containing metal coated filaments 18. The strips 16 of metal coated filaments 18 may be coupled to a power source 20 for heating the strips 16. The blanket 12 may be configured to be used in everyday situations and for emergency situations, such as for use on those suffering from hypothermia. In particular, the blanket 12 may be configured to deliver heat to vital areas of a person, which include, a head, chest and back of the body. The blanket 12 may be formed in multiple forms so that the blanket 12 may be particularly suited for different activities. For instance, the blanket 12 may be configured to be a medical blanket for human or veterinary applications, a stadium blanket, an outdoor blanket used in hunting and fishing applications, and other appropriate configurations. The fabric 14 forming the blanket 12 may be formed from any appropriate material, such as, but not limited to, cotton, nylon, polyester, acrylic, rayon, other polymeric materials, cellulose materials, bioabsorbable materials, any combination thereof, or other appropriate materials. The fabric 14 may be formed in many different patterns, such as, but not limited to, woven, non-woven, ripstop, plain weave, fleece, and other appropriate formations.

The metal coated filaments 18 may be formed from a filament covered by a highly conductive metal. In at least one embodiment, the metal coated filaments 18 may be coated by silver. The silver may be applied to filaments 18 with conventional metallizing techniques, such as chemical deposition and other appropriate methods. The silver coated filaments may be formed using the deposition process described in United States Published Patent Application U.S. 2004/0173056 and in U.S. Pat. No. 4,042,737, both of which are herein incorporated by reference. In at least one embodiment, the metal coated filament 18 may be a silver coated nylon filament, such as X-STATIC, produced by Sauquoit Industries, Inc., Scranton, Pa. The filament 18 may be formed from materials including, but not limited to, nylon and other appropriate materials. The metal coated filaments 18 may be included in the strip 16 in numerous manners. For instance, the metal coated filaments 18 may form all or a portion of the strip 16. In particular, in at least one embodiment, the strip 16 may be formed solely from metal coated filaments 18. In another embodiment, the strip 16 may be formed from a combination of conductive and nonconductive filaments.

In at least one embodiment, the strip 16 may include metal coated filaments 18 in an amount of between about 20 percent and 40 percent by weight of the strip 16. In such an embodiment, the metal coated filament 18 may be formed from staple yarn in a non-woven construction, and the metal coated filament 18 may be needle punched into a fabric. The metal coated filaments 18 may be embroidered, woven, sewn, or knit into any configuration. The metal coated filaments 18 may be embroidered using, for example, a SINGER Quantum XL-6000 Embroidery Machine, an Embroidery Business/Machine—2 TOYOTA 850, or other appropriate device. The metal filaments 18 may be embroidered by plying a 14S and 16Z twist in a yarn of 100 denier, 34 filaments to yield a total of about 260 denier. Once the twisted filament yarn has been prepared, the embroidery can be done on any substrate, such as woven fabrics, non-woven fabrics, or other substrates.

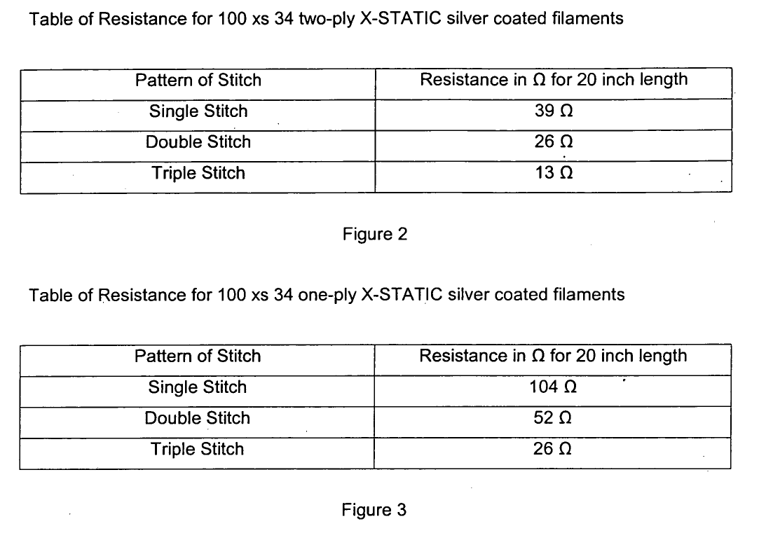

The metal coated filament 18 may be plied multiple times without compromising the integrity of the filament 18. Maintaining the integrity of the filaments 18 aids in the ability to control the resistance of the filament 18 to produce heat at a safe temperature along the length of the filaments 18. In at least one embodiment, the blanket 12 may be configured with the resistance of the metal coated filament 18 being such that the conductive strip 16 of the blanket 12 may be heated to about 105 degrees Fahrenheit. It is preferable that this temperature not be exceeded without taking additional safety precautions to prevent injury, such as a burn, to a person. Resistance may also be controlled through use of embroidery with a repetitive or patterned stitch as known to one of ordinary skill in the art. FIG. 2 depicts different resistance values for the same unit length and same denier (100 xs 34 two-ply silver coated filaments and patterned stitched) of a metal coated filament 18. FIG. 3 depicts resistance values for the same denier used to generate the results depicted in FIG. 2 but in a one-ply configuration. Preferably, the resistance of the metal coated filaments 18 is less than about 100 Ω/□, such as between about 100 Ω/□ and 0.01 Ω/□.

The power source 20 may be any appropriate power source capable of supplying electricity to the metal coated filaments 18. In at least one embodiment, the power source 20 may be a portable power source, such as, but not limited to a battery, such as a conventional 12 volt battery, a portable battery, or any appropriate battery. The configuration of the conductive strips 16 enable a low voltage power source, such as a 12 volt battery, to provide the necessary electricity to heat the strips 16. Such a low voltage system increases the safety of the system. The power source may also be a photovoltaic cell, a municipal power source, or other appropriate power source. In at least one embodiment, the power source 20 may be configured such that the temperature of the blanket 12, and specifically, the conductive strip 16, may be taken from about 30 degrees Fahrenheit to about 105 degrees Fahrenheit for about 2.5 hours.

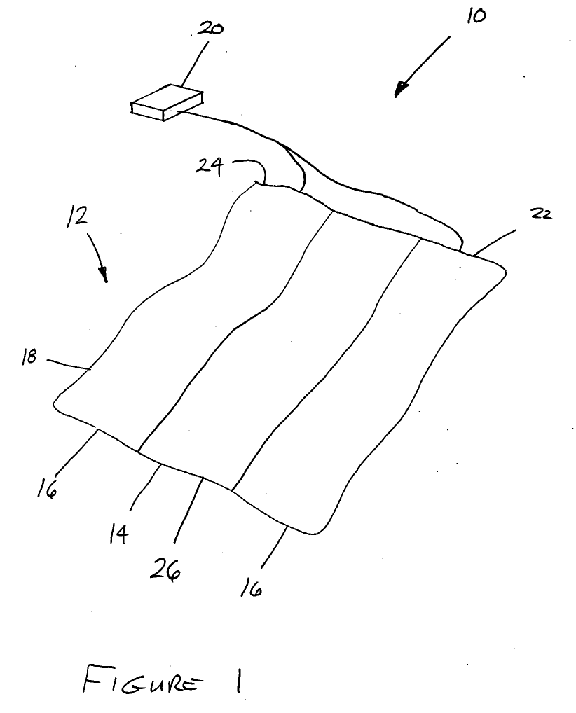

In at least one embodiment, as shown in FIG. 1, the blanket system 10 may be formed from two or more conductive strips 22, 24 separated by a nonconductive strip 26. This pattern may be repeated numerous times across the width of a blanket 12. The conductive strips 22, 24 may be configured to conduct electricity and may be coupled to the power source 20. The conductive strips 22, 24 may be formed in any of the configurations previously described for the strip 16. In particular, the conductive strips 22, 24 may include metal coat filaments 18. The metal coated filaments 18 may form all of or a portion of the conductive strips 22, 24. In at least one embodiment, the conductive strips 22, 24 and the non-conductive strip 26 separating the conductive strips 22, 24 may each be of substantially equal width, as shown in FIG. 1, which may be but is not limited to being, about five inches. The conductive strips 22, 24 may be formed from a fabric that is very flexible and thus comfortable to the person around which the blanket 12 may be wrapped. The metal coated filaments 18 retain the flexibility of a filament without the metal coating. Thus, the metal coated filaments 18 do not exhibit the rigidity of conventional heated blankets having copper wires threaded throughout the blankets.

During use, the blanket system 10 may be used in many applications, as previously mentioned. For instance, the blanket system 10 may be portable and used for emergency purposes. In other applications, the blanket system 10 may be configured to be attachable to a municipal power source, through a conventional receptacle, and thus require access to 110 volt power. The blanket may be positioned in a conventional manner around in person in non-critical situations. However, in critical situations, such as with a person suffering from hypothermia, the blanket 12 may be used to apply to heat to vital aspects, including the head, chest, and back, of a person. The blanket 12 may be positioned on the person to deliver heat to the person. The blanket may be relatively thin and lightweight, and therefore be less cumbersome because of the existence of the conductive strips 16, 24, and 26. In at least one embodiment, the conductive strips 16, 24, and 26 may be configured to be included within a blanket 12 such that the conductive strips as positioned proximate to vital aspects of a person. The power source may be activated to deliver electricity to apply heat to the person for a time period sufficient to stabilize a hypothermic person.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

We claim:

1. A blanket system, comprising:
a fabric formed from a nonconductive material and at least one strip containing metal coated filaments; and
a power source coupled to the at least one strip containing metal coated filaments;
wherein the fabric is configured to apply heat to a vital aspect of a living being.

2. The blanket system of claim 1, wherein the at least one strip containing metal coated filaments comprises a first strip and a second strip that are separated by a third strip, wherein the first and second strips are formed from metal coated filaments for concentrating heat in close proximity to vital aspects of a living being and the third strip is nonconductive, and wherein the power source is coupled to the first strip and the second strip.

3. The blanket system of claim 2, wherein the metal coated filament of the first strip is coated with silver.

4. The blanket system of claim 3, wherein the metal coated filament of the second strip is coated with silver.

5. The blanket system of claim 2, wherein the metal coated filament of the first strip is formed solely of silver coated filaments.

6. The blanket system of claim 5, wherein the metal coated filament of the second strip is formed solely of silver coated filaments.

7. The blanket system of claim 6, wherein the metal coated filament of the third strip is nonconductive.

8. The blanket system of claim 2, wherein the power source is a portable battery.

9. The blanket system of claim 2, wherein the first strip is formed from a fabric having metal coated filaments coupled to the fabric via a needle punch.

10. The blanket system of claim 9, wherein the metal coated filaments of the first strip form between 20 percent and 40 percent of the filament by weight, wherein the filament is a staple yarn in a non-woven construction.

11. The blanket system of claim 9, wherein the second strip is formed from a fabric having metal coated filaments coupled to the fabric via a needle punch.

12. The blanket system of claim 11, wherein the metal coated filaments of the second strip form between 20 percent and 40 percent of the fiber by weight, wherein the filament is a staple yarn in a non-woven construction.

13. The blanket system of claim 2, wherein the fabric is formed from constructions selected from the group consisting of woven, non-woven, ripstop, and plain weave.

14. The blanket system of claim 2, wherein the first, second, and third strips are about five inches in width.

15. The blanket system of claim 1, wherein the resistance of the metal coated filaments is less than about 100 Ω/□.

16. A blanket system, comprising:
a fabric formed from a first strip and a second strip that are separated by a third strip; wherein the first strip is formed from a silver coated filament for concentrating heat in close proximity to vital aspects of a living being and the second strip is formed from a silver coated filament for concentrating heat in close proximity to vital organs of a living being;
a power source coupled to at least one of the first or second strips.

16. The blanket system of claim 15, wherein the silver coated filament of the first strip is formed solely of silver coated filaments, and the silver coated filament of the second strip is formed solely of silver coated filaments.

17. The blanket system of claim 15, wherein the first strip is formed from a fabric having silver coated filaments coupled to the fabric via a needle punch in an amount between 20 percent and 40 percent of the filament by weight, wherein the silver coated filaments are staple yarns in a non-woven construction.

18. The blanket system of claim 15, wherein the second strip is formed from a fabric having silver coated filaments coupled to the fabric via a needle punch in an amount between 20 percent and 40 percent of the filament by weight, wherein the silver coated filaments are staple yarns in a non-woven construction.

19. The blanket system of claim 15, wherein the first, second, and third strips are about five inches in width.

20. A method of heating a living being, comprising:
placing a blanket proximate to vital aspects of the living being wherein the blanket comprises a fabric formed from a first strip and a second strip that are separated by a third strip, wherein the first strip is formed from a metal coated filament and the second strip is formed from a metal coated filament and a power source coupled to at least one of the first or second strips; and
applying electricity to at least one of the first and second strips.

21. The method of claim 20, wherein applying electricity to at least one of the first and second strips comprises applying electricity to at least one of the first and second strips to heat the at least one of the first and second strips to about 105 degrees Fahrenheit.

22. The method of claim 20, wherein placing a blanket proximate to vital sections of the living being comprises placing a blanket in which the first and second strips are formed with silver coated filaments

23. The method of claim 22, wherein placing a blanket proximate to vital sections of the living being comprises placing a blanket in which the first and second strips are formed solely of silver coated filaments.

24. The method of claim 20, wherein placing a blanket proximate to vital sections of the living being comprises placing a blanket in which the first strip is formed from a fabric having metal coated filaments between 20 percent and 40 percent of the fiber by weight coupled to the fabric via a needle punch and the second strip is formed from a fabric having metal coated filaments between 20 percent and 40 percent of the fiber by weight coupled to the fabric via a needle punch.

25. The method of claim 20, wherein placing a blanket proximate to vital aspects of the living being comprises placing a blanket having first and second strips formed from metal coated filaments having a resistance less than about 100 Ω/□.

26. The method of claim 25, wherein the first and second strips formed from metal coated filaments and having a resistance less than about 100 Ω/□ are formed using embroidery.
